(19) United States
(12) Patent Application Publication
(10) Pub. No.: US 2019/0210134 A1
(43) Pub. Date: Jul. 11, 2019

(54) PORTABLE WELDING CARRIAGE WITH FIRE EXTINGUISHER RETAINING MEANS

(71) Applicant: Michael J. Stanton, Las Vegas, NV (US)

(72) Inventor: Michael J. Stanton, Las Vegas, NV (US)

(21) Appl. No.: 15/868,931

(22) Filed: Jan. 11, 2018

(51) Int. Cl. B23K 5/22; A62C 13/78; A62C 3/06; B23K 37/02; B23K 9/32; B62B 1/14; B62B 1/26

(52) U.S. Cl. CPC B23K 5/22; A62C 13/78; A62C 3/065; B62B 2202/022; B23K 9/321; B62B 1/14; B62B 1/264; B23K 37/0282

(57) ABSTRACT

A portable welding carriage with a retaining compartment for receiving a fire extinguisher, the fire extinguisher positioned forwardly of acetylene and oxygen cylinders to protect the same and provide accessibility in exigent circumstances.

### FIELD OF THE INVENTION

This invention relates to welding and metal work, including soldering and brazing of copper and brass, and more particularly relates to an oxygen-acetylene torch carriage.

### BACKGROUND

### Description of the Related Art

Welding stands for acetylene torches are well-known in the art. Acetylene torch carriages for porting cylinders having acetylene with oxygen is are commonly used to cut and weld metal, and required to maintain a distance from the actual cutting torch to mitigate, inter alia, fire hazard involving highly flammable oxygen and acetylene cylinders. Fires commonly break out at the torch, and are not always easily extinguished.

Newer federal and state regulations require technicians/welders using acetylene torches to have a fire extinguisher present. Stands for acetylene torches which offer fire extinguisher retaining means are unknown to those of skill in the art.

Accordingly, a portable welding carriage which provides fire extinguisher retaining means is desirable. It is an object of the present invention to provide a portable welding carriage with fire extinguisher retaining means. Other objects will in part be obvious and will in part appear hereinafter.

### SUMMARY

From the foregoing discussion, it should be apparent that a need exists for a portable welding rig with fire extinguisher retaining means. Beneficially, such a device would overcome inefficiencies with the prior art by providing retaining means for a fire extinguisher.

The present invention has been developed in response to the present state of the art, and in particular, in response to the problems and needs in the art that have not yet been fully solved by currently available apparti. Accordingly, the present invention has been developed to provide an oxygen-acetylene torch carriage comprising: a carriage having an axle and two wheels, the carriage comprising an upwardly rising back support and three staggered forward compartments including an acetylene compartment, an oxygen compartment and a fire extinguisher compartment; wherein the fire extinguisher compartment is positioned forward of the oxygen and acetylene compartments for easier accessibility, wherein the fire extinguisher compartment is smaller in diameter than the oxygen and the acetylene compartments.

The torch carriage may further comprise a forward-mounted spool.

The torch carriage may further comprise fireproof padding lining one or more of the fire extinguisher compartment, the acetylene compartment and the oxygen compartment.

The acetylene compartment may be, in alternate embodiments, adapted to receive an acetylene cylinder and the oxygen compartment is adapted to receive an oxygen cylinder.

A second oxygen-acetylene torch carriage is provide comprising: a carriage having an axle and two wheels, the carriage comprising an upwardly rising back support and three staggered forward compartments including an acetylene compartment, an oxygen compartment and a fire extinguisher compartment; wherein the fire extinguisher compartment is positioned forward of the oxygen and acetylene compartments for easier accessibility, wherein the fire extinguisher compartment is smaller in diameter than the oxygen and the acetylene compartments.

The torch carriage may further comprise a forward-mounted spool.

The torch carriage, in some embodiments, further comprises fireproof padding lining one or more of the fire extinguisher compartment, the acetylene compartment and the oxygen compartment.

The acetylene compartment may be adapted to receive an acetylene cylinder and the oxygen compartment is adapted to receive an oxygen cylinder.

A third oxygen-acetylene torch carriage is provided comprising: a carriage having an axle and two wheels, the carriage comprising an upwardly rising back support and a forwardly-tapered forward chassis; wherein the forward chassis defines three staggered forward compartments including an acetylene compartment, an oxygen compartment and a fire extinguisher compartment; wherein the fire extinguisher compartment is smaller in diameter than the oxygen and the acetylene compartments and is elevated above the acetylene and the oxygen compartment to facilitate expeditious access.

This torch carriage may also further comprise a forward-mounted spool.

The torch carriage may further comprise fireproof padding lining one or more of the fire extinguisher compartment, the acetylene compartment and the oxygen compartment.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a forward perspective view of a portable welding unit with fire extinguisher retaining means in accordance with the present invention;

FIG. 1B is a forward perspective view of a portable welding unit with fire extinguisher retaining means in accordance with the present invention;

FIG. 1C is a forward perspective view of a portable welding unit with fire extinguisher retaining means in accordance with the present invention;

FIG. 1D is a forward perspective view of a portable welding unit with fire extinguisher retaining means in accordance with the present invention; and

FIG. 2 is a forward perspective view of a portable welding unit with fire extinguisher retaining means in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

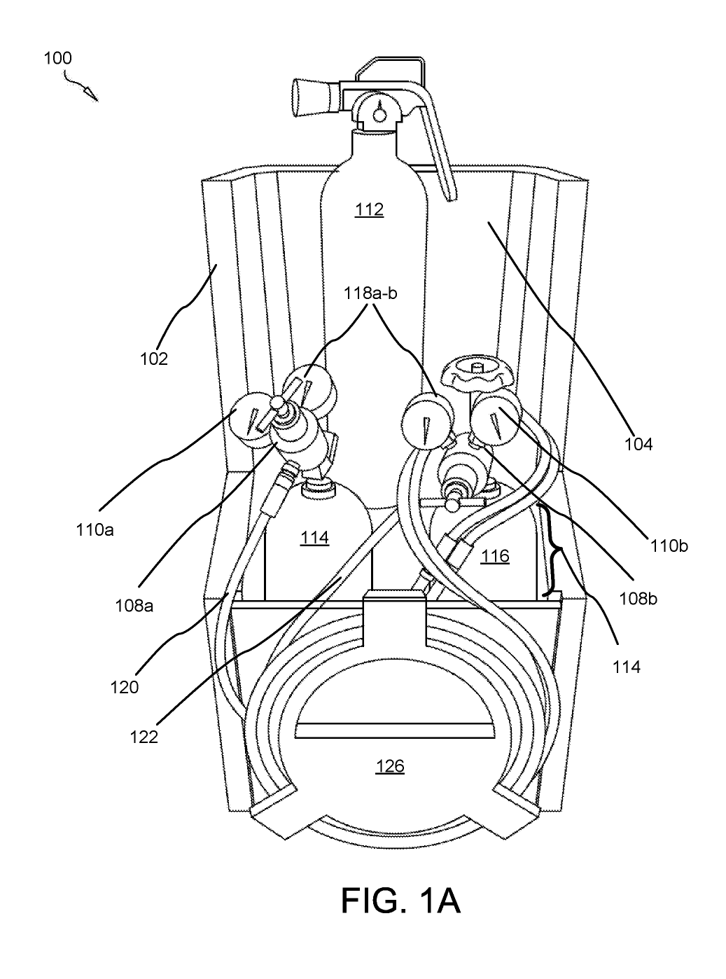

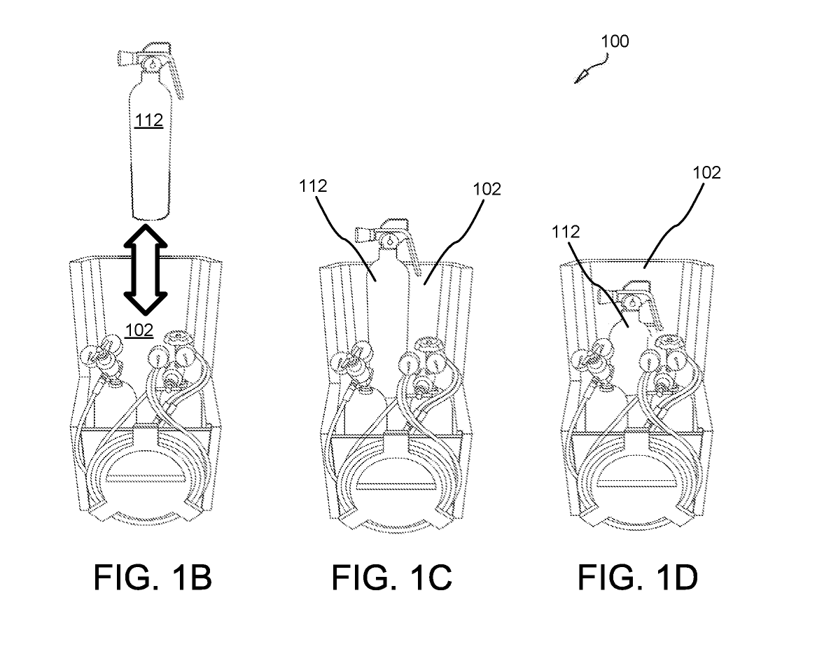

FIG. 1A is a forward perspective view of a portable welding unit 100 with fire extinguisher retaining means in accordance with the present invention. The welding unit 100 comprises a carriage 102 having a back panel 104, the carriage 102 having a forward compartment 114 retaining an acetylene cylinder 114, an oxygen cylinder 116, and a spool 126.

For the purposes of this disclosure the terms “carriage,” “torch stand” 102 and “liquid cylindrical stand” are used interchangeably.

The acetylene cylinder 114 and the oxygen cylinder 116 both comprise a working pressure gauge 110 and cylindrical pressure gauge 118. The pressure gauge 110 and cylindrical pressure gauge 118 are well-known to those of skill in the art. An oxygen hose 122 is affixed at a proximal end to the oxygen cylinder 116 and at a distal end to the torch. An acetylene hose 114 is likewise affixed at a proximal end to the acetylene cylinder 116 and at a distal end to the torch.

A fire extinguisher 112 abuts the back panel 104 and is inserted into the forward compartment 114 behind the cylinders 114, 116. The fire extinguisher 112 may be elevated above the cylinders 114 to make the fire extinguisher 112 more easily accessible in exigent situations a welder or fire extinguisher may face including fire. The floor of the fire extinguisher compartment may likewise be elevated above the floor of the compartments housing the cylinders 114, 116.

FIG. 1B is a forward perspective view of a portable welding unit with fire extinguisher retaining means 100 in accordance with the present invention.

As shown, the fire extinguisher 112 positions behind the cylinders 114 within the carriage 102. The fire extinguisher 112 extracts from the carriage 102.

FIG. 1C is a forward perspective view of a portable welding unit with fire extinguisher retaining means 100 in accordance with the present invention.

The fire extinguisher 112 as shown in partially extracted from the carriage 102.

FIG. 1D is a forward perspective view of a portable welding unit with fire extinguisher retaining means 100 in accordance with the present invention.

In various embodiments, the fire extinguisher 112 positions at an elevated position above the cylinders 114; however, in other embodiments, the fire extinguisher 112 positions below the cylinders 114 or at an equal elevation. Although shown in an elevated position, the fire extinguisher 112 may be shown in delevated position.

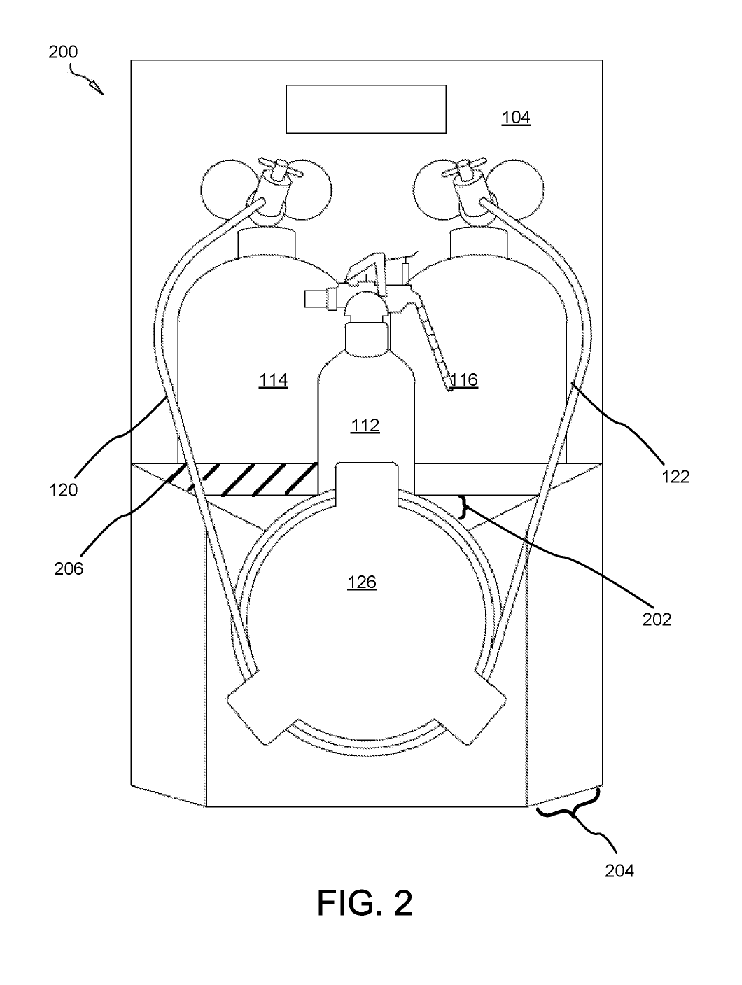

FIG. 2 is a forward perspective view of a portable welding unit 200 with fire extinguisher retaining means in accordance with the present invention. The welding unit 200 comprises a back panel 104 and a forward chassis 204.

The forward chassis 204 is tapered moving away from the back panel 104 to which the forward chassis 204 is affixed. The forward chassis 204 defines a fire extinguisher compartment 202 for retaining the fire extinguisher 117. The fire extinguisher 112 is staggered in front of the cylinders 114, 116 such that it is more easily accessed and protects the cylinders 114, 116 from being struck by objects in front of the carriage 200 which would be otherwise puncture the more dangerous cylinders 114, 116. The compartment 202 may comprise and be lined with fireproof padding 206 to soften impact between one or more of the cylinders 114, 116 and the fire extinguisher 112.

The fire extinguisher 112 is more narrow in diameter than the cylinders 114, 116.

A spool 126 for spooling the hoses 120, 122 is affixed to the forward chassis 204.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An oxygen-acetylene torch carriage comprising:
a carriage comprising an upwardly rising concave back support and three staggered forward compartments including an acetylene compartment, an oxygen compartment and a fire extinguisher compartment;
wherein the fire extinguisher compartment is positioned forward of the oxygen and acetylene compartments for easier accessibility, wherein the fire extinguisher compartment is smaller in diameter than the oxygen and the acetylene compartments and wherein a floor of the fire extinguisher compartment is elevated above a floor of the acetylene compartment;
a working pressure gauge; and
a cylindrical pressure gauge.

2. The torch carriage of claim 1, further comprising a forward-mounted spool.

3. The torch carriage of claim 1, further comprising fireproof padding lining one or more of the fire extinguisher compartment, the acetylene compartment and the oxygen compartment.

4. The torch carriage of claim 1, wherein the acetylene compartment is adapted to receive an acetylene cylinder and the oxygen compartment is adapted to receive an oxygen cylinder.

5. An oxygen-acetylene torch carriage comprising:
carriage comprising an upwardly rising back support and a forwardly-tapered forward chassis;
wherein the forward chassis defines three staggered forward compartments including an acetylene compartment, an oxygen compartment and a fire extinguisher compartment;
wherein the fire extinguisher compartment is smaller in diameter than the oxygen and the acetylene compartments and is elevated above the acetylene and the oxygen compartment to facilitate expeditious access.

6. The torch carriage of claim 5, further comprising a forward-mounted spool.

7. The torch carriage of claim 5, further comprising fireproof padding lining one or more of the fire extinguisher compartment, the acetylene compartment and the oxygen compartment.

8. The torch carriage of claim 5, wherein the fire extinguisher is forwardly-mounted to protect the acetylene cylinder and the oxygen cylinder.

9. An oxygen-acetylene torch carriage consisting of:
a carriage comprising an upwardly-rising concave back support and a forwardly-tapered forward chassis;
wherein the forward chassis defines three staggered forward compartments including an acetylene compartment, an oxygen compartment and a fire extinguisher compartment;
wherein the fire extinguisher compartment is positioned forward of the oxygen and acetylene compartments for easier accessibility, wherein the fire extinguisher compartment is smaller in diameter than the oxygen and the acetylene compartments and is elevated below the acetylene and the oxygen compartment to facilitate expeditious access.

10. The torch carriage of claim 9, further comprising a forward-mounted spool affixed to the forwardly-tapered forward chassis.

11. The torch carriage of claim 9, further comprising fireproof padding lining one or more of the fire extinguisher compartment, the acetylene compartment and the oxygen compartment.

12. The torch carriage of claim 9, wherein the fire extinguisher is forwardly-mounted to protect the acetylene cylinder and the oxygen cylinder.
